(19) United States
(12) Patent Application Publication
(10) Pub. No.: US 2021/0230840 A1
(43) Pub. Date: Jul. 29, 2021

(54) DISPLAY DEVICE FOR EXCAVATOR

(71) Applicant: SUMITOMO HEAVY INDUSTRIES, LTD., Tokyo (JP)

(72) Inventors: Ayano SHINATO, Kanagawa (JP); Masaki OGAWA, Kanagawa (JP); Mengmeng LI, Kanagawa (JP)

(21) Appl. No.: 17/231,186

(22) Filed: Apr. 15, 2021

Related U.S. Application Data
(63) Continuation of application No. PCT/JP2019/040999, filed on Oct. 17, 2019.

(30) Foreign Application Priority Data
Oct. 17, 2018 (JP) 2018-195805

(51) Int. Cl. E02F 9/26; G06F 3/14; G10L 15/22; G10L 15/183; G06F 40/58; B60K 35/00

(52) U.S. Cl. CPC E02F 9/26; G06F 3/14; G10L 15/22; G06F 3/0483; G06F 40/58; B60K 35/00; G10L 15/183

(57) ABSTRACT

A display device for an excavator, includes a communication device, a display, an audio acquiring device configured to collect audio inside a cabin of the excavator, and a converter configured to convert the audio collected by the audio acquiring device into character information. The display displays, in time series, transmission information transmitted from an external terminal and received by the communication device, and the character information output from the converter.

### CROSS REFERENCE TO RELATED APPLICATIONS

This application is a continuation application of International Application No. PCT/JP2019/040999 filed on Oct. 17, 2019 and designated the U.S., which is based upon and claims priority to Japanese Patent Application No. 2018-195805, filed on Oct. 17, 2018, the entire contents of each of which are hereby incorporated by reference.

### BACKGROUND

### 1. Technical Field

The present disclosure relates to display devices for excavators.

### 2. Description of the Related Art

An external operator in a periphery of an excavator may desire to transmit information to an operator of the excavator. There is a proposed excavator provided with a microphone which picks up sound generated in the periphery of a slewing upper structure of the excavator, and a speaker which reproduces the picked up sound through a speaker inside a cabin (or craneman's house) of the excavator.

However, a construction site where the excavator is used is a noisy environment including driving sound of an engine of the excavator, operation sound of heavy machinery, or the like. For this reason, instructions by audio are easily drowned out by the noisy environment, and it is difficult to transmit the instructions by audio to the operator of the excavator.

### SUMMARY

It is desirable to provide a display device for an excavator capable of more reliably transmitting instructions from an external operator to an operator of the excavator.

According to one aspect of the embodiments, a display device for an excavator includes a communication device; a display; an audio acquiring device configured to collect audio inside a cabin of the excavator; and a converter configured to convert the audio collected by the audio acquiring device into character information, wherein the display displays, in time series, transmission information transmitted from an external terminal and received by the communication device, and the character information output from the converter.

Other objects and further features of the present invention will be apparent from the following detailed description when read in conjunction with the accompanying drawings.

### BRIEF DESCRIPTION OF THE DRAWINGS

FIG. 1 is a diagram illustrating an example of a configuration of an information transmission system.

FIG. 2 is a diagram illustrating an example of a configuration of a drive control system of an excavator.

FIG. 3 is a diagram illustrating a first example of a configuration of an image display area of a display device.

FIG. 4 is a diagram illustrating a second example of the image display area of the display device.

FIG. 5 is a diagram illustrating the second example of the image display area of the display device.

FIG. 6 is a diagram illustrating a third example of the image display area of the display device.

FIG. 7 is a diagram illustrating a fourth example of the image display area of the display device.

FIG. 8 is a diagram illustrating a fifth example of the image display area of the display device.

FIG. 9 is a diagram illustrating another example of the configuration of the drive control system of the excavator.

FIG. 10 is a diagram illustrating the example of the configuration of the image display area of the display device.

### DETAILED DESCRIPTION

Hereinafter, embodiments of the present invention will be described, with reference to the drawings. In each of the figures, the same constituent elements are designated by the same reference numerals, and a repeated description of the same constituent elements may be omitted.

Instructions by audio are easily drowned out by the noisy environment in which the excavator is used. Accordingly, it is desirable to provide a display device for an excavator, which can more reliably transmit instructions from an external operator to an operator of the excavator.

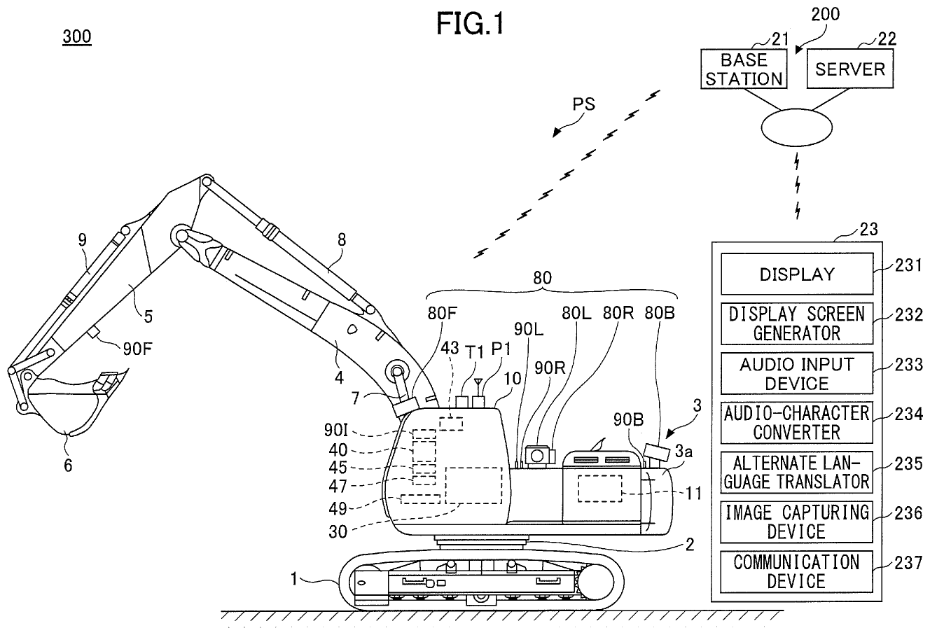

An information transmission system 300 (hereinafter also simply referred to as “system 300”) according to one embodiment will be described, with reference to FIG. 1. FIG. 1 is a diagram illustrating an example of a configuration of the information transmission system 300 according to one embodiment. The system 300 includes an excavator (or shovel) PS, as an example of a heavy machinery, and a communication network 200.

First, a general configuration of the excavator according to a first embodiment will be described, with reference to FIG. 1. FIG. 1 is a side view of the excavator according to the first embodiment.

A slewing upper structure 3 is rotatably mounted on an undercarriage 1 via a slewing mechanism 2. A boom 4 is mounted on the slewing upper structure 3. An arm 5 is mounted on a tip end of the boom 4. A bucket 6 is mounted on a tip end of the arm 5, as an attachment (working device). The attachments may include a slope finishing bucket, a dredging bucket, a breaker, or the like.

The boom 4, the arm 5, and the bucket 6 form drilling attachments, as examples of the attachments, and are hydraulically driven by a boom cylinder 7, an arm cylinder 8, and a bucket cylinder 9, respectively.

The slewing upper structure 3 is provided with a cabin 10, as an operator's cab. A power source, such as an engine 11 or the like, is mounted on the slewing upper structure 3. The power source, such as the engine 11 or the like, is covered by a cover 3a. A controller 30, a display device 40, an audio output device 43, an input device 45, a storage device 47, and a gate lock lever 49 are provided inside the cabin 10. A Global Positioning System (GPS) device (Global Navigation Satellite System (GNSS) receiver) P1, and a communication device T1 are provided on top of the cabin 10.

The controller 30 functions as a main controller (or control device) configured to drive and control the excavator PS. The controller 30 may be formed by a processor, including a Central Processing Unit (CPU) and an internal memory. The controller 30 performs various types of functions by executing one or more programs stored in the internal memory by the CPU, for example. The internal memory is not particularly limited, and may be formed by any suitable computer-readable storage media, including non-transitory computer-readable storage media.

The display device 40 displays an image including various types of operation information in response to the instruction from the controller 30. The display device 40 may be an on-vehicle (or on-board) liquid crystal display connected to controller 30, for example.

The audio output device 43 outputs various types of audio information in response to an audio output instruction from the controller 30. The audio output device 43 may be an on-vehicle speaker connected to controller 30, for example. The audio output device 43 may be an alarm device, such as a buzzer or the like, for example.

The input device 45 is used by the operator of the excavator PS to input various types of information to the controller 30. The input device 45 may include a membrane switch provided on a surface of display device 40, for example. The input device 45 may be a touchscreen panel or the like.

The storage device 47 stores various types of information. The storage device 47 may be a non-volatile storage medium, such as a semiconductor memory or the like, for example. The storage device 47 stores various types of information output from the controller 30 or the like.

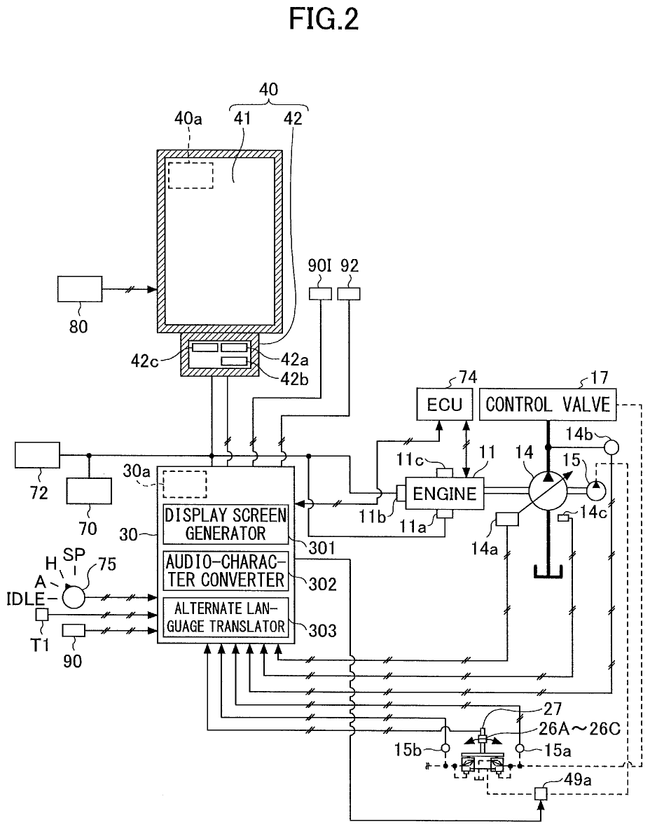

The gate lock lever 49 is provided between a door of the cabin 10 and an operator's seat, and forms a mechanism configured to prevent the excavator PS from being operated erroneously. When the operator sits in the operator's seat and pulls up the gate lock lever 49, the controller 30 controls a gate lock valve 49a, which will be described later in conjunction with FIG. 2, to an open state. In this state, the operator is unable to exit the cabin 10, but is able to operate various types of operating devices. When the operator pushes down the gate lock lever 49, the controller 30 controls the gate lock valve 49a to a closed state. In this state, the operator is able to exit the cabin 10, but is unable to operate the various types of operating devices.

The GPS device P1 detects a position of the excavator PS by the GPS function, and supplies position data to the controller 30.

The communication device T1 transmits information to the outside of the excavator PS.

An imaging device (or image pickup device) 80 is provided at an upper portion of the cover 3a of the slewing upper structure 3. The imaging device 80 includes a front camera 80F configured to capture a front image, a left camera 80L configured to capture a left image, a right camera 80R configured to capture a right image, and a rear camera 80B configured to capture a rear image, with reference to a direction from the slewing upper structure 3 toward the cabin 10. The front camera 80F, the left camera 80L, the right camera 80R, and the rear camera 80B may be digital cameras having imaging devices, such as Charge Coupled Devices (CCDs), Complementary Metal Oxide Semiconductor (CMOS) devices, or the like, for example. Each of the cameras 80F, 80L, 80R, and 80B transmits the captured image to the display device 40 provided inside the cabin 10.

A sound collector 90 includes external microphones, arranged outside the cabin 10, and configured to collect sounds in the periphery of the cabin 10. The external microphones include a left microphone 90L, a right microphone 90R, a rear microphone 90B, and a front microphone 90F. In addition, the sound collector 90 includes an internal microphone 901, arranged inside the cabin 10, and configured to collect sound inside the cabin 10. The internal microphone 901 is an example of an audio acquiring device configured to collect audio inside the cabin 10 of the excavator PS. The sounds collected by the left microphone 90L, the right microphone 90R, the rear microphone 90B, the front microphone 90F, and the internal microphone 901 include a speech sound or the like generated from a person, and mechanical sounds such as an engine noise (or sound) from the excavator PS, a sound (or noise) from the construction site, or the like, for example.

The left microphone 90L, the right microphone 90R and the rear microphone 90B respectively collect (or pick up) the sounds from the left direction, the right direction, and the rear direction, with reference to the direction from the slewing upper structure 3 toward the cabin 10. In this embodiment, the left microphone 90L, the right microphone 90R, and the rear microphone 90B are provided at the upper portion of the cover 3a of the slewing upper structure 3, and are arranged near the left camera 80L, the right camera 80R, and the rear camera BOB, respectively. Further, the left microphone 90L, the right microphone 90R, and the rear microphone 90B are connected to the controller 30, and transmit the collected sounds to the controller 30. Because the left microphone 90L, the right microphone 90R, and the rear microphone 90B are positioned near the left camera 80L, the right camera 80R, and the rear camera 80B, respectively, it is possible to facilitate cable (or wiring) routing. Of course, the left microphone 90L, the right microphone 90R, and the rear microphone 90B may be arranged at an upper portion of the cabin 10, for example.

The front microphone 90F collects the sound from the front direction, with reference to the direction from the slewing upper structure 3 toward the cabin 10. In this embodiment, the front microphone 90F is arranged on the arm 5. The front microphone 90F is connected to the controller 30, and transmits the collected sound to the controller 30. The front microphone 90F may be arranged on the boom 4, the bucket 6, the upper portion of the cabin 10, or the like, for example.

The internal microphone 901 collects the sound inside the cabin 10, such as the speech generated emitted by the operator, for example. In this embodiment, the internal microphone 901 is arranged on an inner wall surface of the cabin 10. The internal microphone 901 is connected to controller 30, and transmits the collected sound to controller 30. The internal microphone 901 may be embedded in the display device 40, for example.

The left microphone 90L, the right microphone 90R, the rear microphone 90B, the front microphone 90F, and the internal microphone 901 may respectively be a unidirectional microphone that is sensitive to sound from a particular direction, for example. However, one microphone may be used to implement the functions of two or more microphones among the left microphone 90L, the right microphone 90R, the rear microphone 90B, and the front microphone 90F, using a nondirectional (or omnidirectional) microphone that uniformly collects sounds from all directions. In this case, it is possible to reduce the number of microphones that collect the sounds in the periphery of the excavator PS.

The communication network 200 is formed mainly of a base station 21, a server 22, and a portable (or mobile) communication terminal 23. The base station 21, the server 22, and the portable communication terminal 23 may connect to and communicate with each other using a communication protocol, such as the Internet protocol or the like, for example. The number of each of the excavator PS, the base station 21, the server 22, and the portable communication terminal 23 that are provided, may be one or more. Examples of the portable communication terminal 23 include laptop computers, cellular phones, smartphones, earphones with microphones, or the like, for example.

The base station 21 is an external facility configured to receive the information transmitted from the excavator PS, and transmits information to and receives information from the excavator PS via a satellite communication network, a cellular telephone communication network, the Internet network, or the like, for example.

The server 22 functions as a management device for the excavator PS. In this embodiment, the server 22 is set up at the external facility, such as a management center or the like, and stores and manages the information transmitted from the excavator PS and the portable communication terminal 23. The server 22 may be a computer which includes a CPU, a Read Only Memory (ROM), a Random Access Memory (RAM), an Input/Output (I/O) interface, an input device, a display, or the like, for example. More particularly, the server 22 acquires and stores the information transmitted from the portable communication terminal 23, via the communication network 200, and transmits the information to the excavator PS. Further, the server 22 acquires and stores the information transmitted from the excavator PS, via the communication network 200, and transmits the information to the portable communication terminal 23.

The portable communication terminal 23 functions as a support device for the excavator PS. In this embodiment, the portable communication terminal 23 is carried by the external operator, and is used as a device for transmitting work instructions to the operator inside the cabin 10 of the excavator PS. The portable communication terminal 23 may be a computer including a CPU, a ROM, a RAM, an I/O interface, an input device, a display, or the like, for example.

The portable communication terminal 23 includes a display 231, a display screen generator 232, an audio input device 233, an audio-to-character converter (hereinafter simply referred to as “audio-character converter”) 234, an alternate language translator 235, an image capturing device (or imaging device) 236, and a communication device 237.

Various types of information are displayed on the display 231. The display screen generator 232 generates a display screen that is displayed on the display 231.

The audio input device 233 may include a microphone or the like, for example, and is configured to acquire audio information. The audio input device 233 may include an acknowledge switch (not illustrated). The audio input device 233 acquires the audio. Accordingly, the audio input device 233 can prevent unintended audio from being input.

The audio-character converter 234 is configured to convert the audio information input from the audio input device 233 into character information (or text). The alternate language translator 235 translates the character information in a first language and converted by the audio-character converter 234, into a second language different from the first language (that is, another language).

The image capturing device 236 may be a digital camera having an imaging device, such as the CCDs, the CMOS devices, or the like, for example.

The communication device 237 is configured to communicate with the server 22 via the communication network 200. More particularly, the converted character information from the audio-character converter 234, the translated character information from the alternate language translator 235, and the captured image from the image capturing device 236 are transmitted to the server 22 via the communication device 237.

Next, an example of a configuration of a drive control system of an excavator PS will be described with reference to FIG. 2. FIG. 2 is a diagram illustrating the example of the configuration of the drive control system of the excavator PS. In FIG. 2, a mechanical power system, a high-pressure hydraulic line, a pilot line, and an electric drive control system are indicated by a double line, a bold solid line, a dashed line, and a thin solid line, respectively.

The display device 40 displays an image including the operation information or the like supplied from controller 30. The display device 40 is connected to controller 30 via a communication network, such as a Controller Area Network (CAN), a Local Interconnect Network (LIN), or the like, a dedicated line, or the like, for example. Moreover, the display device 40 includes a conversion processing device 40a configured to generate an image to be displayed on an image display area 41, and a switch panel 42, as the input device.

The conversion processing device 40a generates the image to be displayed in the image display area 41, including the captured image, based on image data obtained from the imaging device 80. The display device 40 receives the image data from each of the front camera 80F, the left camera 80L, the right camera 80R, and the rear camera 80B. In addition, the conversion processing device 40a converts data to be displayed in the image display area 41, among the various types of data input to the display device 40 from the controller 30, into image signals. The data input from the controller 30 to the display device 40 include data indicating a temperature of an engine coolant, data indicating a temperature of hydraulic oil, data indicating an urea water level (remaining amount of urea water), data indicating a fuel level (remaining amount of fuel), or the like, for example. The conversion processing device 40a outputs the converted image signals to the image display area 41, and causes the image display area 41 to display the image generated based on the captured image and the various types of data. The conversion processing device 40a may be provided in the controller 30, for example, instead of being provided in the display device 40. In this case, imaging device 80 (the front camera 80F, the left camera 80L, the right camera 80R, and the rear camera 80B) is connected to controller 30.

The switch panel 42 may include various types of hardware switches. The switch panel 42 includes a light switch 42a, a wiper switch 42b, and a window washer switch 42c.

The light switch 42a is configured to switch on and off states of lights mounted on outside the cabin 10. The wiper switch 42b is configured to switch on and off states of a wiper. The window washer switch 42c is configured to switch on and off states of spraying a window washer liquid.

The display device 40 operates in response to receiving power supplied from a battery 70. The battery 70 is charged by power generated from an alternator 11a (or generator) of the engine 11. The power from the battery 70 is also supplied to electrical components 72 or the like of the excavator PS, other than the controller 30 and the display device 40. Moreover, a starter 11b of the engine 11 is driven by the power supplied from the battery 70, thereby starting the engine 11.

The engine 11 is connected to a main pump 14 and a pilot pump 15, and is controlled by an Engine Control Unit (ECU) 74. Various types of data indicating a state of the engine 11 (for example, data indicating the coolant temperature (physical quantity) detected by a coolant temperature sensor 11c) are constantly (or continuously) transmitted from the ECU 74 to the controller 30. The controller 30 stores the received data in an internal storage device 30a, and can transmit the stored data to the display device 40, as appropriate

The main pump 14 may be a hydraulic pump configured to supply the hydraulic oil to a control valve 17 via the high-pressure hydraulic line. The main pump 14 may be a swash plate type variable displacement hydraulic pump, for example.

The pilot pump 15 may be a hydraulic pump configured to supply the hydraulic oil to various types of hydraulic control devices via the pilot line. The pilot pump 15 may be a fixed displacement hydraulic pump, for example.

The control valve 17 may be a hydraulic control device configured to control the hydraulic system of the excavator PS. The control valve 17 selectively supplies the hydraulic oil discharged from the main pump 14 to the boom cylinder 7, the arm cylinder 8, the bucket cylinder 9, a crawler hydraulic motor, a swing hydraulic motor, or the like, for example. In the following description, the boom cylinder 7, the arm cylinder 8, the bucket cylinder 9, the crawler hydraulic motor, and the swing hydraulic motor may simply be referred to as “hydraulic actuators”.

Operating levers 26A through 26C are provided inside the cabin 10, and may be used by the operator to operate the hydraulic actuators. When the operation levers 26A through 26C are operated, the hydraulic oil from the pilot pump 15 is supplied to pilot ports of flow control valves corresponding to each of the hydraulic actuators. Each pilot port is supplied with the hydraulic oil with a pressure in accordance with the operating direction and amount of the corresponding one of the operation levers 26A through 26C.

In this embodiment, the operation lever 26A is a boom operation lever. When the operator operates the operation lever 26A, the boom cylinder 7 is hydraulically driven to operate the boom 4. The operation lever 26B is an arm operation lever. When the operator operates the operation lever 26B, the arm cylinder 8 is hydraulically driven to operate the arm 5. The operation lever 26C is a bucket operation lever. When the operator operates the operation lever 26C, the bucket cylinder 9 is hydraulically driven to operate the bucket 6. In addition to the operation levers 26A through 26C, the excavator PS may be provided with operation levers for driving the crawler hydraulic motor and the swing hydraulic motor, an operation pedal, or the like.

The controller 30 acquires the various types of data which will be described below, for example. The data acquired by the controller 30 are stored in the storage device 30a.

A regulator 14a of the main pump 14, which is a variable displacement hydraulic pump, transmits data indicating of a swash plate angle to the controller 30. In addition, a discharge pressure sensor 14b transmits data indicating a discharge pressure of the main pump 14 to the controller 30. These data (data indicating physical quantities) are stored in the storage device 30a. Moreover, an oil temperature sensor 14c, provided in a pipeline between the main pump 14 and a tank which stores the hydraulic oil drawn by the main pump 14, transmits data, indicating a temperature of the hydraulic oil flowing through the pipeline, to the controller 30.

Pressure sensors 15a and 15b detect a pilot pressure supplied to control valve 17 when the operation levers 26A through 26C are operated, and transmit data indicating the detected pilot pressure to the controller 30. At least one switch button 27 is provided on at least one of the operation levers 26A through 26C. The operator can operate the switch button 27 while operating the operation levers 26A through 26C, that is, without taking the operator's hand off the operation levers 26A through 26C. In addition, instruction signals allocated to the switch button 27 can be transmitted to the controller 30 when the operator operates the switch button 27.

An engine speed adjustment dial 75 is provided inside the cabin 10. The engine speed adjustment dial 75 is configured to adjust the engine speed, and may adjust the engine speed (Revolutions Per Minute (RPM)) in steps, for example. In this embodiment, the engine speed adjustment dial 75 is provided to enable switching of the engine speed into four steps, namely, an SP mode, an H mode, an A mode, and an idling (IDLE) mode. The engine speed adjustment dial 75 transmits data indicating a set state (or speed mode) of the engine speed to the controller 30. FIG. 2 illustrates a state where the H mode is selected by the engine speed adjustment dial 75.

The SP mode utilizes the highest engine speed, and is selected when placing priority on an output (amount of work performed by the operation). The H mode utilizes the second highest engine speed, and is selected when placing priority on both the output and fuel consumption (that is, reduction of fuel consumption). The mode A utilizes the third highest engine speed, and is selected when placing priority on the fuel consumption, while operating the excavator PS with low noise. The idling mode utilizes a lowest engine speed, and is selected when placing priority on putting the engine into an idling state. The engine 11 is controlled to a constant engine speed in accordance with the speed mode set by the engine speed adjustment dial 75.

Next, a functional configuration of the controller 30 will be described. As illustrated in FIG. 2, the controller 30 includes a display screen generator 301, an audio-character converter 302, and an alternate language translator 303.

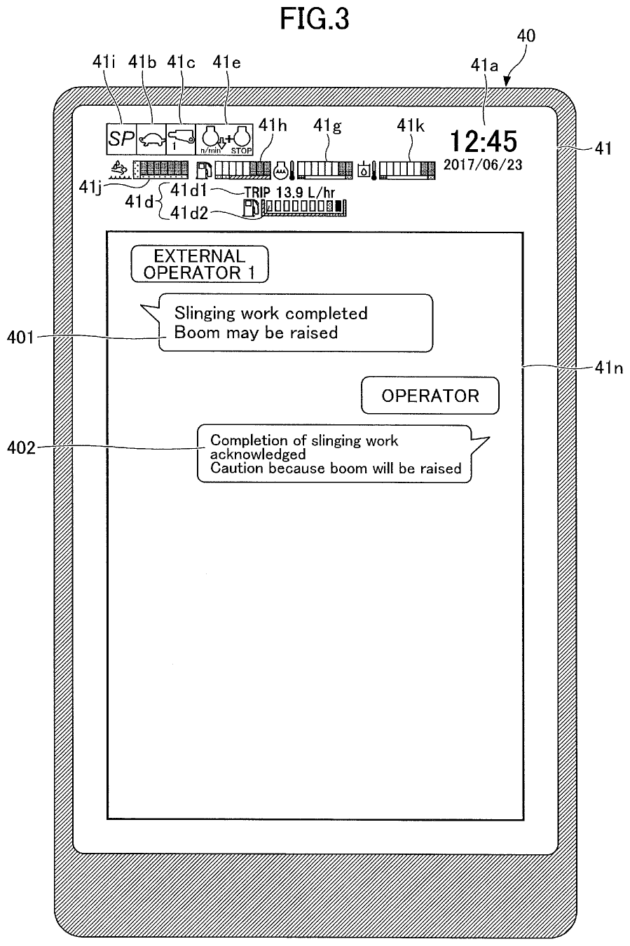

The display screen generator 301 generates a display screen to be displayed in the image display area 41. A display example on the display screen will be described later, with reference to FIG. 3 or the like.

The audio-character converter 302 converts the audio information input from the internal microphone 901 into the character information. The internal microphone 901 is provided with a microphone switch 92, and the audio-character converter 302 converts the audio information that is input when the microphone switch 92 is operated into the character information. For example, the microphone switch 92 is a momentary type switch, and the audio-character converter 302 acquires the audio input from the internal microphone 901 while the microphone switch 92 is pressed and operated. When the microphone switch 92 is released and no longer operated, the audio-character converter 302 stops acquiring the audio input. The microphone switch 92 may be an alternate type switch which maintains the operated state even after being released, or may be switches of other types. The microphone switch 92 prevents unintended audio from being input from the internal microphone 901.

Further, a microphone function of the portable communication terminal carried by the operator inside the cabin 10, such as the smartphone or the like, may be used in place of the internal microphone 901. The microphone function of the portable communication terminal, carried by the operator inside the cabin 10, is an example of an audio acquiring device configured to collect audio inside the cabin 10 of the excavator PS. In this case, the portable communication terminal carried by the operator and the controller 30 may be connected via a wireless communication such as a near field communication, or via a cable communication. In this case, an audio-character conversion function, which is built into the portable communication terminal carried by the operator, may be used in place of the audio-character converter 302 of the controller 30.

The alternate language translator 303 translates the converted character information from the audio-character converter 302 into another language. The converted character information from the audio-character converter 302 and the translated character information from the alternate language translator 235 are transmitted to the server 22 via the communication device T1.

Next, an example of a configuration of the image display area 41 of the display device 40 will be described, with reference to FIG. 3. FIG. 3 is a diagram illustrating a first example of the configuration of the image display area 41 of the display device 40. In this example, FIG. 3 illustrates a state where the image display area 41 displays an exchange between the operator and the external operator, as character information.

First, the image display area 41 will be described. As illustrated in FIG. 3, the image display area 41 includes a date and time display area 41a, a crawler mode display area 41b, an attachment display area 41c, a fuel consumption display area 41d, an engine control state display area 41e, a coolant temperature display area 41g, a fuel level display area 41h, a speed mode display area 41i, an urea water level display area 41j, a hydraulic oil temperature display area 41k, and an information display area 41n.

The crawler mode display area 41b, the attachment display area 41c, the engine control state display area 41e, and the speed mode display area 41i are areas for displaying set state information related to set states of the excavator PS. The fuel consumption display area 41d, the coolant temperature display area 41g, the fuel level display area 41h, the urea water level display area 41j, and the hydraulic oil temperature display area 41k are areas for displaying operation state information related to operation states of the excavator PS.

More particularly, the date and time display area 41a is the area for displaying the current date and time. The crawler mode display area 41b is the area for displaying the current crawler mode. The attachment display area 41c is the area for displaying an image representing the attachment that is currently attached. The fuel consumption display area 41d is the area for displaying fuel consumption information calculated by the controller 30. The fuel consumption display area 41d includes an average fuel consumption display area 41dl for displaying a lifelong average fuel consumption or an interval average fuel consumption, and an instantaneous fuel consumption display area 41d2 for displaying an instantaneous fuel consumption.

The engine control state display area 41e is the area for displaying a control state of the engine 11. The coolant temperature display area 41g is the area for displaying a current temperature state of the engine coolant. The fuel level display area 41h is the area for displaying the fuel level of the fuel stored in a fuel tank. The speed mode display area 41i is the area for displaying an image of the current speed mode that is set by the engine speed adjustment dial 75. The urea water level display area 41j is the area for displaying an image of the level of the urea water stored in an urea water tank. The hydraulic oil temperature display area 41k is the area for displaying a temperature state of the hydraulic oil inside a hydraulic oil tank.

The information display area 41n displays the exchange between the external operator carrying the portable communication terminal 23, and the operator of the excavator PS, as the character information.

For example, when the external operator carrying the portable communication terminal 23 desires to communicate with the operator inside the cabin 10 of the excavator PS, in order to send instructions or the like, the external operator speaks into the audio input device 233 of the portable communication terminal 23. The audio input device 233 acquires the audio of the external operator. The audio acquired by the audio input device 233 is converted into the character information by the audio-character converter 234. In addition, the character information is translated by the alternate language translator 235, as appropriate. The communication device 237 transmits the converted character information from the audio-character converter 234, and the translated character information from the alternate language translator 235, to the server 22. Further, the display screen generator 232 displays these converted character information and translated character information in an information display area of the display 231, as character information.

The server 22 stores the character information acquired from the portable communication terminal 23, and transmits the acquired character information to the excavator PS via the base station 21.

The display screen generator 301 of the excavator PS displays the character information from the portable communication terminal 23 in the information display area 41n of the image display area 41, as character information 401. Hence, the operator inside the cabin 10 can receive the instructions from the external operator by viewing the information display area 41n of the display device 40.

The operator turns on the microphone switch 92 and speaks to the internal microphone 901, when communicating with the external operator, such as when responding to the instructions or the like. The internal microphone 901 acquires the audio (or voice) of the operator. The audio acquired by the internal microphone 901 is converted into the character information by the audio-character converter 302. In addition, the character information is translated by the alternate language translator 303, as appropriate. The communication device T1 transmits the converted character information from the audio-character converter 302 and the translated character information from the alternate language translator 303 to the server 22, via the base station 21. Further, the display screen generator 301 displays these character information as the character information 402 in the information display area 41n of the image display area 41.

The server 22 stores the character information acquired from the excavator PS, and transmits the acquired character information to the portable communication terminal 23.

The display screen generator 232 of the portable communication terminal 23 displays the character information from the excavator PS in the information display area of the display 231, as the character information. Accordingly, the external operator can receive the instructions from the operator of the excavator PS, by viewing the display 231 of the portable communication terminal 23.

As described above, the excavator PS according to this embodiment can display, in time series, the instructions from the external operator in the information display area 41n of the image display area 41, as the character information. For this reason, the excavator PS can transmit the instructions or the like from the external operator outside the excavator PS, to the operator inside the cabin 10 even at the construction site of the excavator PS which is used in the noisy environment. Moreover, the excavator PS can transmit the response or the like from the operator of the excavator PS to the external operator.

When the external operator issues the work instructions by speech, and the issued instructions are converted into the character information and transmitted to the operator of the excavator PS, thereby facilitating issuance of the work instructions. In addition, the operator of the excavator PS can respond to the work instructions by speech, and the response by speech is converted into the character information and transmitted the external operator, thereby facilitating the acknowledgement, response, or the like.

The server 22 may manage logs of the work instructions from the external operator, the responses or the like from the operator, or the like.

Further, because the character information is translated by the alternate language translators 235 and 303, it is possible to smoothly and reliably transmit both the work instructions from the external operator and the responses or the like from the operator of the excavator PS, even if the external operator and the operator of the excavator PS do not share a common language or understanding of the common language is limited, such as when mother tongues of the external operator and the operator of the excavator PS are different, for example.

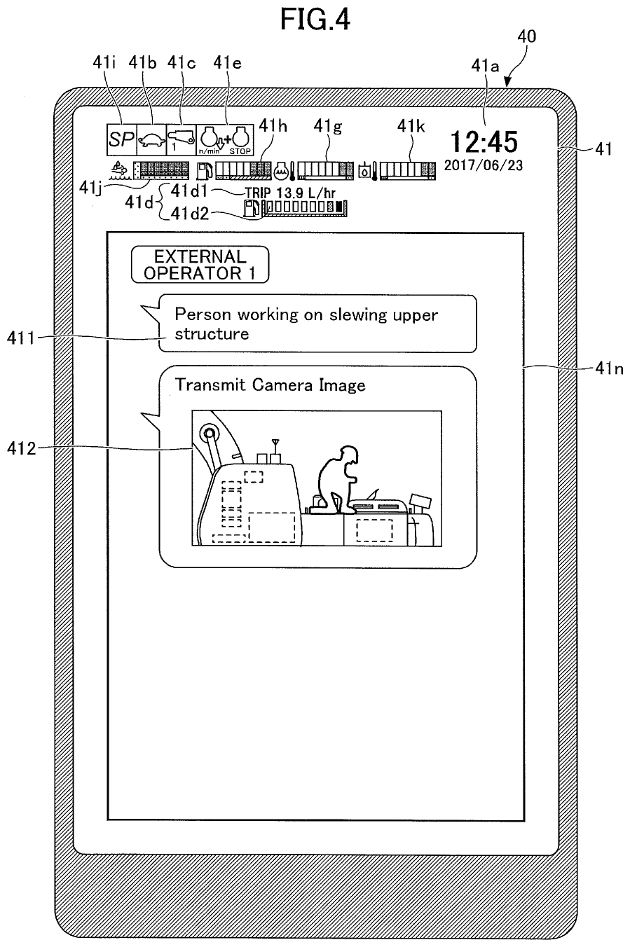

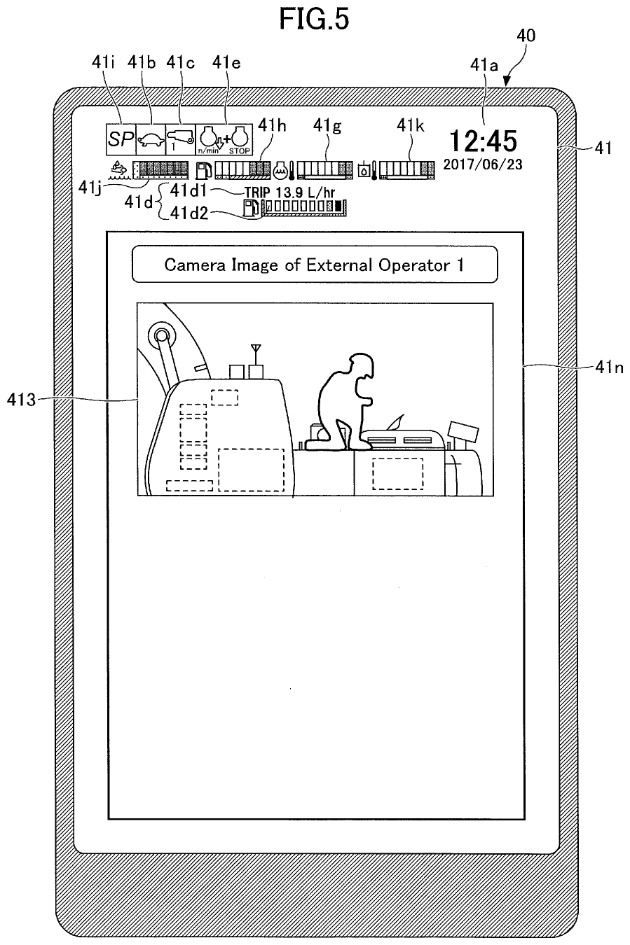

Next, another example of the configuration of the image display area 41 of the display device 40 will be described, with reference to FIG. 4 and FIG. 5. FIG. 4 and FIG. 5 are diagrams illustrating a second example of the configuration of the image display area 41 of the display device 40. In the second example illustrated in FIG. 4 and FIG. 5, an image is added to the image display area 41 when the operator of the excavator PS and the external operator communicate with each other. Further, an example will be described in which a person is working on the upper surface of the slewing upper structure 3 of the excavator PS, and this person is positioned at a blind spot when viewed from the operator inside the cabin 10 and also at a blind spot when viewed from the imaging device 80 of the excavator PS.

The external operator carrying the portable communication terminal 23 issues the instructions by speech by speaking into the audio input device 233 of the portable communication terminal 23. In addition, the external operator captures an image by the image capturing device 236 of the portable communication terminal 23. In this example, the external operator captures the image of the person working on the upper surface of the slewing upper structure 3 of the excavator PS. The audio input device 233 acquires the audio of the external operator. The audio of the external operator, acquired by the audio input device 233, is converted into the character information by the audio-character converter 234. Further, the character information is translated by the alternate language translator 235, as appropriate. The communication device 237 transmits the converted character information from the audio-character converter 234 (and the translated character information from the alternate language translator 235, as appropriate), and the image captured by the image capturing device 236, to the server 22. The display screen generator 232 displays the character information and the image in the information display area of the display 231, as character information and image.

The server 22 stores the character information and the image acquired from the portable communication terminal 23, and transmits the acquired character information and image to the excavator PS, via the base station 21.

The display screen generator 301 of the excavator PS displays the character information from the portable communication terminal 23 in the information display area 41n of the image display area 41, as character information 411. In addition, the display screen generator 301 displays the image from the portable communication terminal 23 in the information display area 41n of the image display area 41, as a reduced thumbnail image 412.

Moreover, when the operator performs an thumbnail enlarge operation to enlarge the thumbnail image 412, the display screen generator 301 displays an enlarged thumbnail image 413 in the information display area 41n, as illustrated in FIG. 5. The operator can perform the thumbnail enlarge operation by making an audio input of a predetermined keyword, for example. The controller 30 includes an audio content identifier which identifies an audio content acquired by the internal microphone 901. The audio content identifier determines whether or not the audio content includes an audio instruction corresponding to the thumbnail enlarge operation. When the audio content identifier determines that the audio instruction corresponding to the thumbnail enlarge operation is included in the audio content, the audio content identifier notifies the presence of the audio instruction corresponding to the thumbnail enlarge operation to the display screen generator 301. When the audio instruction corresponding to the thumbnail enlarge operation is notified from the audio content identifier, the display screen generator 301 displays the enlarged thumbnail image 413 in the information display area 41n. The thumbnail enlarge operation is not particularly limited, and may be instructed by an operation of tapping the thumbnail image 412, an operation of a predetermined switch, or the like, for example.

As described above, the excavator PS according to this embodiment can display the image captured by the image capturing device 236 of the portable communication terminal 23 in the information display area 41n. Accordingly, the operator of the excavator PS can confirm the state of the blind spots from the operator and the imaging device 80.

In addition, although the transmitted image is the image captured by the image capturing device 236 in the described example, the transmitted image is not limited thereto. For example, the transmitted image may be an image stored in the storage device of the portable communication terminal 23, such as a working diagram, a map, a graph showing operation progress, a weather forecast map, or the like. Accordingly, it is possible to smoothly and reliably exchange information between the external operator and the operator of the excavator PS.

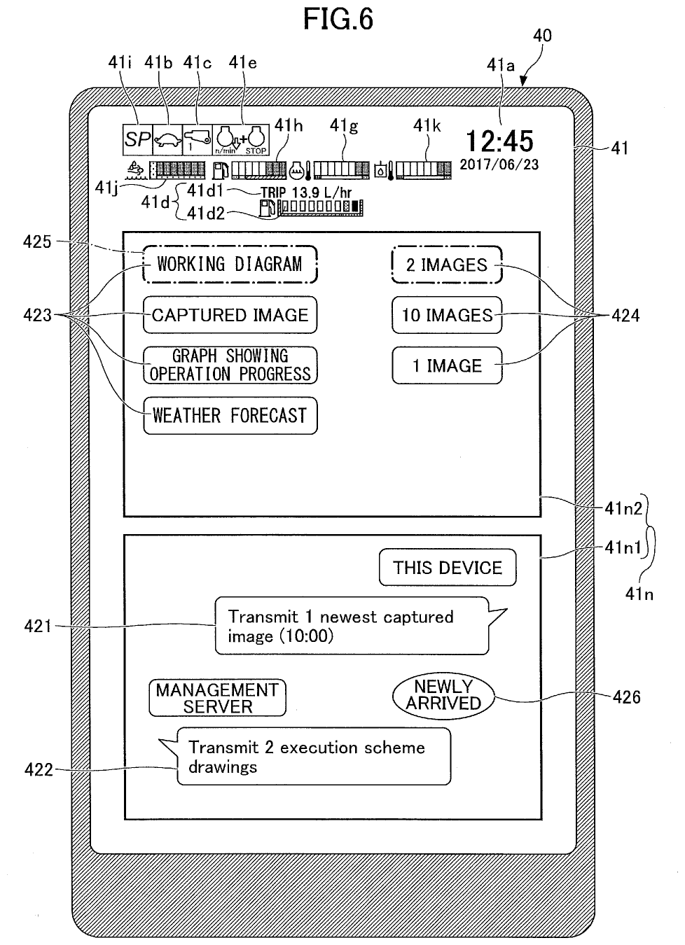

Next, another example of the configuration of the image display area 41 of the display device 40 will be described, with reference to FIG. 6. FIG. 6 is a diagram illustrating a third example of the configuration of the image display area 41 of the display device 40.

In the configuration illustrated in FIG. 6, the information display area 41n includes a character display area 41n1 for displaying character information, and a tab area 41n2 for arranging tabs 423 for displaying information other than the character information. The display screen generator 301 identifies the character information, and image information other than the character information, from the information transmitted from the portable communication terminal 23.

The character display area 41n1 displays the character information of the characters to which the audio of the external operator and the operator is converted, and character information 421 and 422 of the logs when the excavator PS, the server 22, and the portable communication terminal 23 transmit the images.

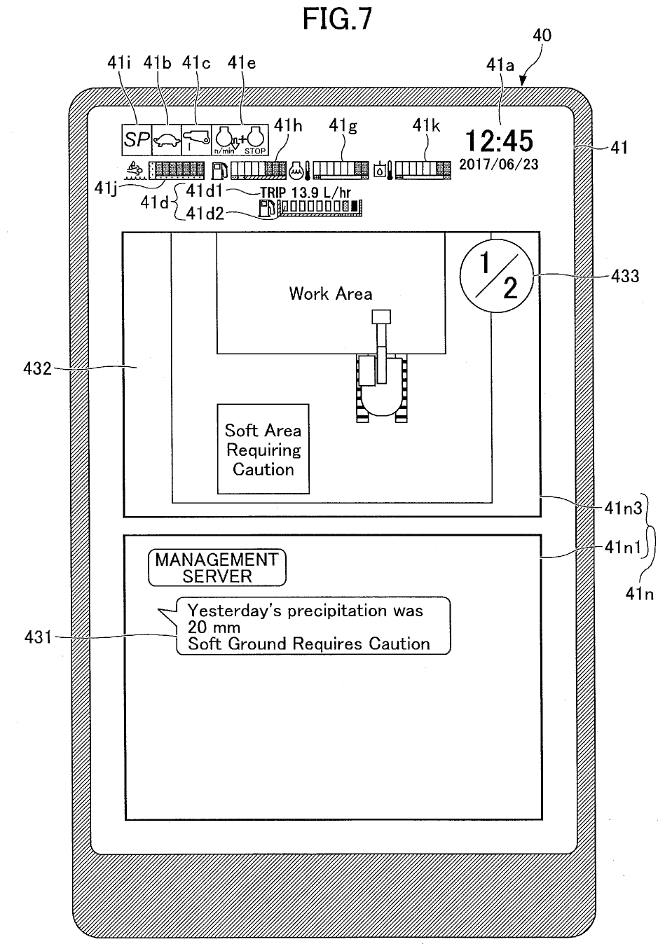

The tabs 423 are arranged in the tab area 41n2 for each of the categories of the transmitted image. In the example illustrated in FIG. 6, the categories include “Working Diagram”, “Captured Image”, “Graph Showing Operation Progress”, and “Weather Forecast”. The tabs 423 are displayed as selection buttons for selecting the “Working Diagram”, “Captured Image”, “Graph Showing Operation Progress”, “Weather Forecast”, or the like. If the operator selects the “Working diagram” by an operation such as touching the screen, the working diagram illustrated in FIG. 7 which will be described later is displayed in the image display area 41n3. If the operator selects the “Captured Image”, “Graph Showing Operation Progress”, or “Weather Forecast”, the screen switches to a corresponding screen. In addition, if a plurality of images are included in the category, the number of images is displayed in a number display are 424. Alternatively, the operator may select one of the tabs 423 to display a list of images of the category corresponding to the selected tab 423 in the information display area 41n.

For example, when the server 22 transmits two execution scheme drawings to the excavator PS, the character display area 41n1 displays the character information 422 indicating that the images have been transmitted. Moreover, in the tab region 41n2, one of the corresponding tabs 423 is highlighted by a highlight indication 425 which is indicated by a bold one-dot chain line in FIG. 6. Further, a newly-arrived indication 426, indicating that the character information 422 is a newly arrived message, is added to the character display area 41n1.

As described above, the excavator PS according to this embodiment can easily display the required image, even if the log of the character information displayed in the character display region 41n1 becomes long. In addition, the images are categorized and managed separately as images that are opened many times as the operation progresses, such as the working diagram, and images that are opened once but unlikely opened again, such as the captured image. As a result, even if the number of transmitted images increases, the operator does not need to perform an operation, such as searching for the working diagram from a large number of images, and an operation efficiency of inspecting the images can be improved.

Next, another example of the configuration of the image display area 41 of the display device 40 will be described, with reference to FIG. 7. FIG. 7 is a diagram illustrating a fourth example of the configuration of the image display area 41 of the display device 40.

In the configuration illustrated in FIG. 7, the information display area 41n includes the character display area 41n1 for displaying the character information 431, and an image display area 41n3 for displaying an image 432, such as the map, the working diagram, or the like.

The image 432, such as the map, the working diagram, or the like, for example, can be displayed constantly (or continuously) in the image display area 41n3. A number display 433 is displayed in the image display area 41n3. The number display 433 indicates, for example, that a first image of the two images of the working diagram is being displayed.

As described above, the excavator PS according to this embodiment can constantly display the image 432, such as the map, the working diagram, or the like, in the image display area 41n3. Hence, when the operator performs an operation, the operator is not required to perform an operation for causing the display of the map, the working diagram, or the like, thereby improving the operation efficiency of the original operation to be performed by the operator.

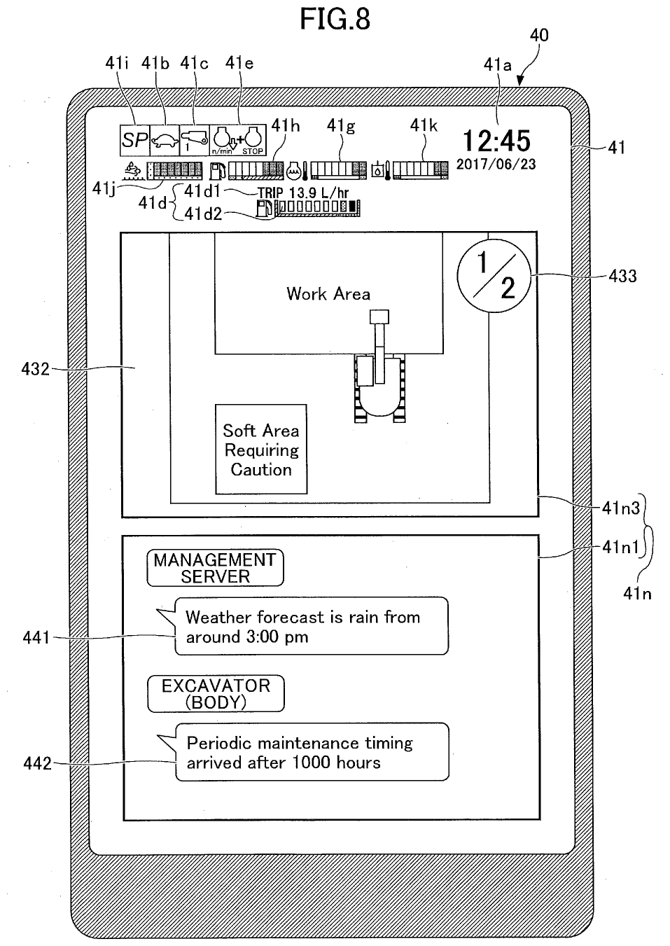

Next, another example of the configuration of the image display area 41 of the display device 40 will be described, with reference to FIG. 8. FIG. 8 is a diagram illustrating a fifth example of the configuration of the image display area 41 of the display device 40.

In the configuration illustrated in FIG. 8, the information display area 41n includes the character display area 41n1 for displaying character information 441 and 442 in time series, and the image display area 41n3 for displaying the image 432, such as the map, the working diagram, or the like.

The character display area 41n1 displays the character information 441 of the log when the server 22 transmits information. For example, weather information transmitted from the server 22 is displayed as the character information 441. In addition, the character display area 41n1 displays a determination result of the controller 30, that is, an excavator body, as the character information 442.

For example, the controller 30 determines whether or not a periodic (or routine) maintenance timing arrived, based on a cumulative operation time of the excavator PS. When the periodic maintenance timing arrives, the character information 442 indicating this arrival of the periodic maintenance timing is displayed in the character display area 41n1, as illustrated in FIG. 8.

In addition, the controller 30 determines whether or not the excavator PS is in a state where a warning, such as overheating or the like, is to be generated, based on the data from the various types of sensors provided in the excavator PS. When the controller 30 determines that the excavator PS is in the state where the warning is to be generated, character information corresponding to the warning is displayed in the character display area 41n1.

Moreover, the controller 30 determines whether or not a continuous operation time of the operator exceeds a predetermined time, based on a continuous operation time of the excavator PS. If the continuous operation time of the operator exceeds a predetermined time, character information urging the operator to rest is displayed in the character display area 41n1.

Further, the controller 30 determines a change in weather, based on the weather information transmitted from the server 22. If the weather changes, character information indicating the change in the weather is displayed in the character display area 41n1.

Although the determination result of the excavator body is displayed in the character display area 41n1, as the character information, in the example described above, the display of the determination result is not limited to such. For example, the determination result of the excavator body may be displayed in the information display area 41n, as an image of an icon or the like.

As described above, the excavator PS according to this embodiment can display the determination result of the excavator PS (or controller 30) in the information display area 41n. For this reason, the operator can easily recognize the determination result of the excavator PS (or controller 30).

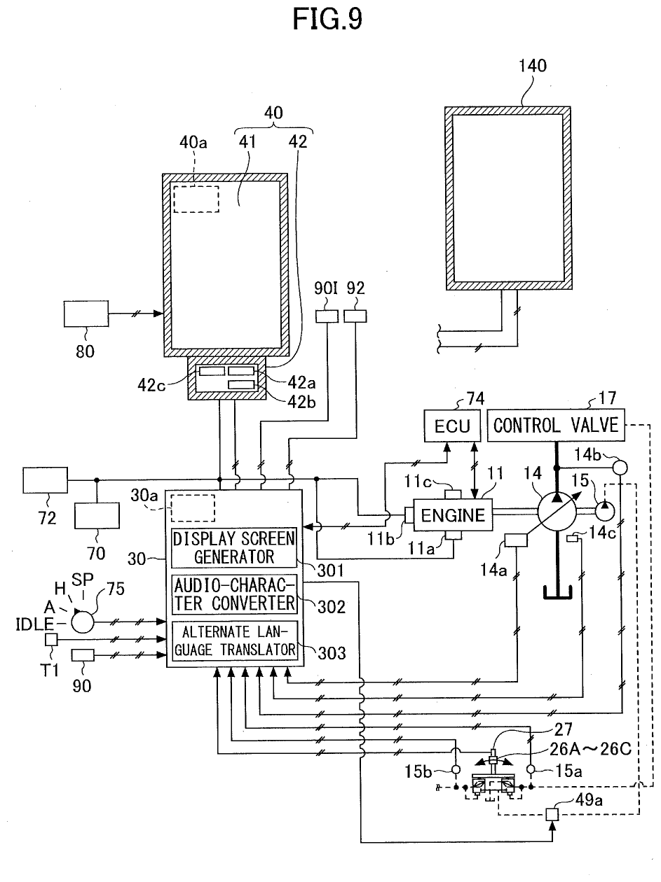

Next, another example of the configuration of the drive control system of the excavator PS will be described, with reference to FIG. 9. FIG. 9 is a diagram illustrating the other example of the configuration of the drive control system of the excavator PS.

As illustrated in FIG. 9, the excavator PS may include a second display device 140, in addition to the display device 40. Otherwise, the configuration illustrated in FIG. 9 is similar to the configuration illustrated in FIG. 2, and a repeated description of the same constituent elements may be omitted.

The second display device 140 may be arranged inside the excavator PS (for example, inside the cabin 10), or may be carried by an operator outside the excavator PS. The second display device 140 is communicably connected to the controller 30 via a cable (for example, a communication network such as a CAN, a LIN, a dedicated line, or the like), a near field communication, or the communication network 200. In addition, the second display device 140 may operate by receiving power supplied from the battery 70, or operate using power supplied from a built-in battery of the second display device 140.

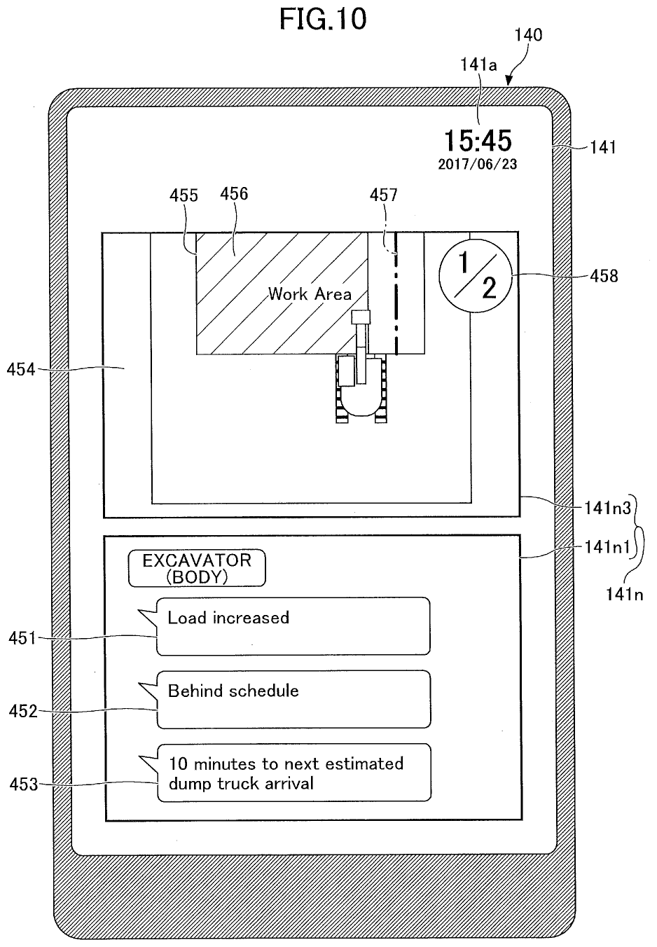

Next, an example of the configuration of the image display area 141 of the second display device 140 will be described, with reference to FIG. 10. FIG. 10 is a diagram illustrating the example of the configuration of the image display area 141 of the second display device 140.

In the configuration illustrated in FIG. 10, an information display area 141n includes a character display area 141n1 for displaying character information 451 through 453 in time series, and an image display area 141n3 for displaying an image 454, such as the map, the working diagram, or the like.

The character display area 141n1 displays the determination result of the excavator body, as the character information 451 through 453.

For example, the controller 30 determines whether or not a load on the attachment is greater than or equal to a predetermined value, based on the data from the various types of sensors provided in the excavator PS. If the load on the attachment is greater than or equal to the predetermined value, the character information 451 indicating that the load of the attachment increased (or increased considerably) is displayed in the character display area 141n1.

In addition, the controller 30 determines the operation progress, based on the current time, the working diagram, an operation log of the excavator PS, or the like, for example. If the operation progress is behind schedule, the character information 452 indicating the delay of the operation from the schedule is displayed in the character display area 141n1.

Further, a dump truck (not illustrated) transmits information (for example, the position information) of the dump truck to the server 22 which functions as the management device, via the communication network 200. The position information of the dump truck is input to the controller 30 of the excavator PS, from the server 22 via the communication network 200. The controller 30 estimates an expected arrival time of the dump truck, based on the position information of the dump truck. The character display area 141n1 displays the character information 453 indicating the estimated arrival time of the dump truck.

The image display area 141n3 constantly displays the image 454, such as the map, the working diagram, or the like, for example. The image 454 indicates today's work area (or work target) 455. In addition, the image display area 141n3 displays a work completed area (actual area in which the work is completed) 456, based on the operation log of the excavator PS. In FIG. 10, the work completed area 456 is indicated by a hatching. A date and time display area 141a displays the current date and time. The controller 30 estimates a work schedule for the current time, based on the current time, the work target 455, the operation log of the excavator PS, or the like. The image display area 141n3 displays a work schedule 457 for the current time. In FIG. 10, the work schedule 457 for the current time is indicated by a one-dot chain line. Moreover, a number display 458 is displayed in the image display area 141n3. The number display 458 indicates, for example, that a first image of the two received images of the working diagram is being displayed.

As described above, the excavator PS according to this embodiment can display the work target 455, the work completed area 456, and the work schedule 457 for the current time in the information display area 41n. For this reason, the operator of the excavator PS and operator outside the excavator PS can easily recognize the operation progress. In addition, the excavator PS according to this embodiment can display the determination result of the excavator PS (controller 30) in the information display area 141n. Hence, the operator can easily recognize the determination result of the excavator PS (controller 30).

Although the present disclosure is described in conjunction with the embodiments, the present disclosure is not limited to the embodiments, and various variations, modifications, and substitutions may be made within the scope of the present disclosure.

FIG. 4 and FIG. 5 illustrate an example in which the image taken by the external worker is displayed, but the image that is displayed is not particularly limited. For example, an image captured by an imaging device provided on another heavy machinery, such as another excavator, may be displayed. In this case, a controller of the other excavator may determine the shape of the excavator, the shape of the person, and the positional relationship of the excavator and the person, and transmit the image and the determination result to the excavator PS. Thus, the operator of the excavator PS can be aware of the person working on the excavator PS, not only from the image captured by the imaging device of the excavator body, but also from the image captured by the other excavator, for example. In addition, an image captured by a fixed-point camera, such as a surveillance camera or the like, installed at the construction site, may be displayed in the display area in place of or in addition to the image captured by the other heavy machinery.

The screens illustrated in FIG. 3 through FIG. 8 are described for the case where the screen is displayed on the display device 40, but the display of the screens is not limited to such. The screens may be displayed on the second display device 140 or the portable communication terminal 23. Further, the screen illustrated in FIG. 10 is described with for the case where the screen is displayed on the second display device 140, but the display of this screen is not limited to such. For example, and this screen may be displayed on the display device 40 or the portable communication terminal 23.

In the examples described above, the audio input is accepted by operating the microphone switch 92, but the audio input acceptance is not limited to such. For example, when a predetermined start word is detected, the audio-character converters 234 and 302 may use the audio of the detected start word and subsequent words as the audio input.

According to the embodiments, before transmitting the character information from the excavator PS or the portable communication terminal 23 to the server 22, the character information is translated by the alternate language translators 235 and 303, however, the transmission of the character information is not limited such. For example, the excavator PS or the portable communication terminal 23 may transmit the character information to the server 22, and the character information received from the server 22 may be translated by the alternate language translators 235 and 303, to thereby display the translated character information.

Moreover, the display contents displayed in the information display area 41n, the character display area 41n1, and the tab area 41n2 of the image display area 41 may be synchronized to the display screens of the portable communication terminal 23 and the server 22. In this case, the external operator or administrator (or manager) can confirm the contents visually recognized by the operator of the excavator PS. For this reason, communication with the operator can be ensured.

Further, in the embodiments, although the excavator PS and the portable communication terminal 23 communicate via the server 22, the communication is not limited to such. For example, the excavator PS and the portable communication terminal 23 may directly communicate with each other.

In addition, the character information displayed in the time series may include dump information transmitted from the management device.

According to the embodiments described above, it is possible provide a display device for an excavator capable of more reliably transmitting instructions from an external operator to an operator of the excavator.

It should be understood that the invention is not limited to the above described embodiments, but may be modified into various forms on the basis of the spirit of the invention. Additionally, the variations and modifications are included in the scope of the invention.

For example, the display device for the excavator may include a communication device, and a display, wherein the display displays, in time series, transmission information transmitted from an external terminal and received by the communication device, and a determination result of a controller of the excavator, as character information. The character information displayed in time series may include character information generated by a management device. The display may include a tab for each of categories of images. The character information displayed in time series may include character information related to a maintenance timing.

Further, the display device for the excavator may include a communication device, a display, an audio acquiring device configured to collect audio inside a cabin of the excavator, and a converter configured to convert the audio collected by the audio acquiring device into character information, wherein the display displays transmission information, including information related to soft ground, transmitted from an external terminal and received by the communication device, and the information related to the soft ground. The display may further display information related to weather.

What is claimed is:

1. A display device for an excavator, comprising:
a communication device;
a display;
an audio acquiring device configured to collect audio inside a cabin of the excavator; and
a converter configured to convert the audio collected by the audio acquiring device into character information,
wherein the display displays, in time series,
transmission information transmitted from an external terminal and received by the communication device, and
the character information output from the converter.

2. The display device for the excavator as claimed in claim 1, wherein the transmission information includes at least one of character information, maps, working diagrams, and images.

3. The display device for the excavator as claimed in claim 1, further comprising:
a switch configured to switch between collecting and not collecting the sound by the audio acquiring device.

4. The display device for the excavator device as claimed in claim 1, further comprising:
a language translator configured to translate the character information in a first language and output from the converter, into character information in a second language different from the first language.

5. The display device for the excavator as claimed in claim 1, further comprising:
an audio content identifier configured to identify an audio content of the audio collected by the audio acquiring device,
wherein display switches a display image thereof based on the identification result of the audio content identifier.

6. The display device for the excavator as claimed in claim 1, further comprising:
a display screen generator configured to identify character information, and image information other than the character information, from the transmission information,
wherein the display displays a tab corresponding to the image information.

7. The display device for the excavator as claimed in claim 1, wherein the display includes an area constantly displaying a map or a working diagram.

8. A display device for an excavator, comprising:
a communication device; and
a display,
wherein the display displays, in time series,
transmission information transmitted from an external terminal and received by the communication device, and
a determination result of a controller of the excavator, as character information.

9. The display device for the excavator as claimed in claim 8, wherein the character information displayed in the time series includes a determination result of a control device of another excavator.

10. The display device for the excavator as claimed in claim 8, wherein the character information displayed in the time series includes dump information transmitted from a management device.

11. The display device for the excavator as claimed in claim 8, wherein the character information displayed in time series includes character information generated by a management device.

12. The display device for the excavator as claimed in claim 8, wherein the display includes a tab for each of categories of images.

13. The display device for the excavator as claimed in claim 8, wherein the character information displayed in time series includes character information related to a maintenance timing.

14. A display device for an excavator, comprising:
a communication device;
a display;
an audio acquiring device configured to collect audio inside a cabin of the excavator; and
a converter configured to convert the audio collected by the audio acquiring device into character information,
wherein the display displays
transmission information, including information related to soft ground, transmitted from an external terminal and received by the communication device, and
the information related to the soft ground.

15. The display device for the excavator as claimed in claim 14, wherein the display further displays information related to weather.
